(19) United States
(12) Patent Application Publication
(10) Pub. No.: US 2008/0154757 A1
(43) Pub. Date: Jun. 26, 2008

(54) METHOD TO COMPETE FOR CREDIT CARD BUSINESS AT THE POINT OF SALE

(75) Inventors: Mark A. Barros, Wellington, FL (US); Juan C. Fernandez, Boca Raton, FL (US); David J. Hayes, Lake Worth, FL (US); Jorge L. Perdomo, Boca Raton, FL (US)

Correspondence Address: CUENOT & FORSYTHE, L.L.C., 12230 FOREST HILL BLVD., SUITE 120, WELLINGTON, FL, 33414, US

(73) Assignee: MOTOROLA, INC., Schaumburg, IL (US)

(21) Appl. No.: 11/616,057

(22) Filed: Dec. 26, 2006

(51) Int. Cl. G07G 1/14; G06Q 30/00; G06Q 20/00

(52) U.S. Cl. 705/35; 705/14

(57) ABSTRACT

A method (400) of conducting a financial transaction. The method can include receiving from each of a plurality of credit providers an offer (130) indicating an incentive (125) available to a user for using an established credit account to make payment for the financial transaction at a point-of-sale terminal (110), and presenting the offers to the user. The user can be prompted to select one of the established credit accounts to make payment for the financial transaction.

### BACKGROUND OF THE INVENTION

1. Field of the Invention

The present invention generally relates to processing of payment transactions at point-of-sale terminals.

2. Background of the Invention

Credit card companies typically rely on advertising and incentives to attract and retain customers. Examples of common incentives are competitive interest rates, bonuses, perks, and special offers. When a consumer has multiple credit cards from which to choose during a financial transaction, getting the consumer to select a particular card can be difficult.

Consumers have different reasons for using one card over another based on a complex series of factors. Some consumers choose the credit card with the lowest interest rate, the credit card with the most flexible payment schedule, or the card that provides the greatest number of reward points. Other consumers may simply choose the credit cards that are on top in their wallets.

As consumers begin to transition from using physical credit cards kept in their wallets to accessing credit accounts electronically using electronic devices, the methodology used by consumers for choosing credit accounts to make payment in financial transactions may change. Credit card companies are likely to need more tools to compete in influencing consumers in their credit account selection.

### SUMMARY OF THE INVENTION

The present invention relates to a method of conducting a financial transaction. The method can include receiving from each of a plurality of credit providers an offer indicating an incentive available to a user for using an established credit account to make payment for the financial transaction at a point-of-sale terminal, and presenting the offers to the user. Receiving the offer can include receiving the offer from the point-of-sale terminal, a portable electronic device, a computer or a network node. The user can be prompted to select one of the established credit accounts to make payment for the financial transaction.

The method also can include receiving an identifier associated with each of a plurality of the established credit accounts. Receiving the identifiers can include receiving the identifiers from a portable electronic device. Receiving the identifiers also can include receiving a user input.

The method further can include, in response to initiation of the financial transaction, communicating transaction information to the at least one of the credit providers. In such an arrangement, receiving the offer indicating the incentive can include receiving the offer in response to the transaction information. Further, communicating the transaction information can include communicating an identifier for a location where the financial transaction is taking place or a business name at the location. Communicating the transaction information also can include communicating an identifier for a type of business associated with the financial transaction or a type of product or service that is the subject of the financial transaction.

The present invention also relates to a method of conducting a financial transaction, which includes receiving from an electronic device or a point-of-sale terminal transaction information for a financial transaction at the point-of-sale terminal and communicating an offer to be presented to a user of the electronic device. The offer can indicate an incentive to be provided if a particular credit account is used to make payment for a financial transaction at the point-of-sale terminal.

The method further can include processing the transaction information and selecting the incentive based upon the transaction information. Receiving the transaction information can include receiving an identifier for a location where the financial transaction is taking place, other credit accounts being considered for use, or at least one competing offer. Receiving the transaction information also can include receiving a purchase amount, an identifier of a type of item being purchased, or an identifier of a specific item being purchased. Moreover, receiving the transaction information can include receiving an identifier for a type of business associated with the financial transaction or a type of product or service that is the subject of the financial transaction.

The method also can include processing financial information associated with the credit account and selecting the incentive based upon the financial information. Processing the financial information associated with the credit account can include processing a credit rating or a payment history.

The present invention also relates to an electronic device suitably configured to make a payment at a point-of-sale terminal. The electronic device can include a transceiver that receives from at least one credit provider an offer indicating an incentive available to an electronic device user for using a particular credit account identified on the electronic device to make payment for a financial transaction at a point-of-sale terminal. The electronic device further can include a user interface that, in response to initiation of the financial transaction, presents the incentive to the user. The user interface also can prompt the electronic device user to select one credit account from among a plurality of credit accounts available to make payment for the financial transaction. Further, the transceiver can automatically receive the offer in response to initiation of the financial transaction. The transceiver can receive the offer from the point-of-sale terminal or a network node.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention;

FIG. 2 depicts a block diagram of an electronic device that is useful for understanding the present invention;

FIG. 3 depicts a block diagram of a network node that is useful for understanding the present invention;

FIG. 4 is a flowchart that is useful for understanding the present invention; and

FIG. 5 is another flowchart that is useful for understanding the present invention.

### DETAILED DESCRIPTION

While the specification concludes with claims defining features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The present invention relates to a method of conducting a financial transaction at a point-of-sale terminal. More specifically, a credit provider can communicate current incentives available to a consumer if the consumer uses a credit account established with the credit provider to make payment in the financial transaction. For example, the incentives can be communicated to the consumer via the point-of-sale terminal, a computer, or the consumer's electronic device. Accordingly, the present invention enables credit providers to compete for a customer's business when the customer is engaged in a financial transaction at a point-of-sale terminal.

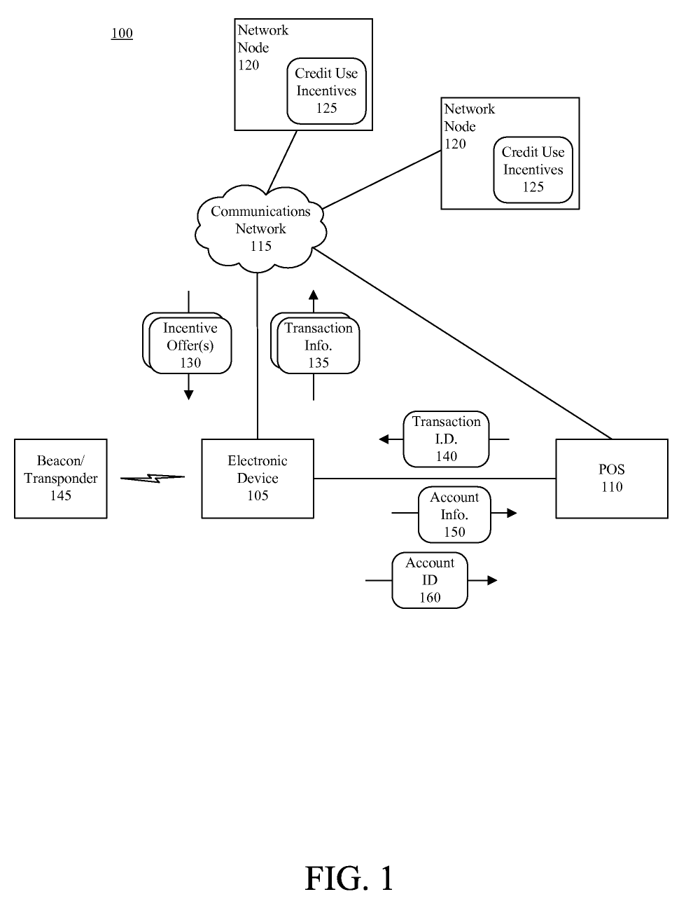

FIG. 1 depicts a communications system 100 that is useful for understanding the present invention. The communications system 100 can include an electronic device 105. In one arrangement the electronic device 105 can be a portable electronic device, such as a mobile station (e.g. a mobile telephone, a mobile radio, a personal digital assistant, or a mobile computer), or any other suitably configured wireless communication device. In another arrangement, the electronic device 105 can be a portable data storage device, for instance a radio frequency identifier (RFID) or a flash drive. In yet another arrangement, the electronic device 105 can comprise a plurality of RFIDs. For example, the electronic device 105 can comprise a plurality of credit cards, each of which comprises its own RFID. Still, the electronic device 105 can be any other device that can communicate RF or other electromagnetic signals to a point-of-sale terminal 110 in order to make payments in financial transactions.

In one arrangement, the electronic device 105 can wirelessly communicate with the point-of-sale terminal 110 to make contactless payments. As used herein, the term “contactless payment” means a payment transaction in which the electronic device 105 need not physically contact the point-of-sale terminal 110 in order to communicate credit account information. For example, the electronic device 105 can communicate with the point-of-sale terminal 110 in accordance with a near field communication (NFC) protocol, IEEE 802.11, Bluetooth or ZigBee, infrared signaling, or any other suitable wireless communications protocol.

In another arrangement, the electronic device 105 can be configured to communicate with the point-of-sale terminal 110 in another suitable manner, for instance via a wired connection. For example, the electronic device 105 can communicate with the point-of-sale terminal 110 via a universal serial bus (USB) port, and IEEE-1394 port, or any other suitable communications port. In an arrangement in which the electronic device 105 is a computer, the electronic device 105 can communicate with the point-of-sale terminal 110 via the communications network 115 or via a direct connection.

The communications network 115 can comprise, for example, the Internet, the World Wide Web, a wide area network (WAN), a local area network (LAN), a cellular communications network, a dispatch communications network, an interconnect communications network, a public switched telephone network (PSTN), and/or any other networks or systems over which communication signals can be propagated. In that regard, the communications network 115 can include wired and/or wireless communication links.

In an arrangement in which the electronic device 105 comprises a plurality of conventional credit cards, information can be communicated from the credit cards to the of point-sale-terminal by swiping the credit cards through a magnetic reader in a conventional fashion. Alternatively, credit account numbers can be manually entered into the point-of-sale terminal 110 or electronically transferred to the point-of-sale network via a communications network 115. Still, the credit account information 150 can be communicated to point-of-sale terminal 110 in any other suitable manner and the invention is not limited in this regard.

The point-of-sale terminal 110 can be a stationary or portable device. For instance, in a grocery store the point-of-sale terminal 110 can be located at a check-out counter. For transactions over the communications network 115, the point-of-sale terminal 110 can be an application instantiated on a network node 120, for example on a server. In a restaurant, the point-of-sale terminal 110 can be presented to a user at the user's table for payment processing. The point-of-sale terminal 110 also can be implemented in any other suitable manner and the invention is not limited in this regard.

The point-of-sale 110 terminal can comprise one or more communications adapters suitable for receiving credit account information and/or communicating with a server for credit authorizations. For instance the point-of-sale terminal 110 can include one or more suitable communications ports, infrared ports, wireless transceivers, communications modems, or the like.

In one aspect of the inventive arrangements, the electronic device 105 can be configured to communicate with one or more network nodes 120 via a communications network 115. The network nodes 120 can be web servers, network servers, local area network servers, or any other network nodes which can communicate information to the electronic device 105 via the communications network 115. Suitable security protocols can be implemented by the network node 120, the communications network 115 and/or the electronic device 105 to protect against unauthorized access to the information being communicated.

In operation, the electronic device 105 or the point-of-sale terminal 110 can receive one or more offers 130 of incentives 125 available to the user if the user makes payment for the financial transaction using a particular credit account, and present such offers 130 to a user. For example, if the user has four different credit accounts, one or more of the financial institutions with which the credit accounts are established can generate the offers 130 to entice the user to use their respective credit accounts.

An incentive 125 being communicated in an offer 130 can include an interest rate, reward points, a reward point multiplier, a financial reward, a desirable payment structure, or any other benefit that can be provided for use of a particular credit account. For example, an incentive 125 can include a discounted interest rate, cash back and/or reward points applicable to the current financial transaction. Further, an incentive 125 can multiply any reward points earned during the transaction by a particular value. For instance, an incentive 125 can double, triple or quadruple the reward points. Still, any other incentives can be generated by the network nodes 120 and any such incentives are within the scope of the present invention.

In one arrangement, a network node 120 which generates incentives 125 can be associated with each financial institution. Alternatively, a single network node 120 can generate the incentives for a plurality of financial institutions. In such an arrangement, the financial institutions can be communicatively linked to the network node 120 and can periodically update their incentive information.

The incentives 125 can be determined in any suitable manner. For example, the incentives can be based upon a business (e.g. business name), the type of business and/or a location where the financial transaction is taking place. The incentives also can be based on the types of items and/or services being purchased, a specific product or service that is the subject of the financial transaction, and/or a purchase amount. Further, the incentives can be based on other credit accounts being considered for use, competitive offers, a credit rating or a payment history associated with a credit account, a time of day, a day of the week/month/year, and so on. Such information can be provided as transaction information 135 communicated to the network nodes 120 by the electronic device 105 and/or the point-of-sale terminal 110. For example, transaction information 135 can be communicated to the network nodes 120 in response to initiation of the financial transaction. The transaction information 135 also can include one or more identifiers of credit accounts being considered for use in making payment for the financial transaction. Accordingly, the network nodes 120 can associate the transaction information 135 with one or more credit accounts. Further, the network nodes 120 can process the transaction information 135 using incentive generation algorithms that generate the incentives 125.

In an arrangement in which the electronic device 105 communicates the transaction information 135 to the network nodes 120, the electronic device 105 can first receive a transaction identifier 140 from the point-of-sale terminal 110. The electronic device can parse the transaction identifier 140 to identify relevant information and include at least a portion of such information in the transaction information 135 communicated to the network nodes.

In lieu of receiving the transaction identifier 140 from the point-of-sale terminal 110, the electronic device 105 also can receive the transaction identifier 140 from a beacon or transponder 145 associated with the point-of-sale terminal 110. In such an arrangement the transaction identifier 140 can be received wirelessly by the electronic device 105. In another arrangement, the transaction identifier 140 can be manually entered into the electronic device 105. Still, the transaction identifier 140 can be received by the electronic device 105 in any suitable manner and the invention is not limited in this regard.

In an arrangement in which the point-of-sale terminal 110 communicates the transaction information 135 to the network node(s) 120, the electronic device 105 can communicate account information 150 to the point-of-sale terminal 110 indicating which credit accounts may be considered to make payment in the financial transaction. The account information 150 can identify any of the credit accounts available to the electronic device 105, or credit accounts selected by a user or selected based on user preferences or settings. As noted, such information also can be manually entered into the point-of-sale terminal 110. The point-of-sale terminal 110 can communicate the information to the network node(s) 120 via the communications network 115 or in any other suitable manner.

Regardless of how the transaction information 135 is communicated to the network nodes or how the offers 130 are communicated to the electronic device 105 and/or the point-of-sale terminal 110, the offers 130 can be presented to the user and the user may consider the offers 130 when choosing which credit account to use to make payment in the financial transaction. In one arrangement, the offers 130 can be presented to the user via the electronic device's user interface. In another arrangement, the offers 130 can be communicated to the point-of-sale terminal 110. In this arrangement, the point-of-sale terminal 110 can communicate the offers 130 to the electronic device 105 for presentation to the user, or the point-of-sale terminal 110 can present the incentive offer(s) 130 via its own user interface.

The electronic device 105 or the point-of-sale terminal 110 can automatically prompt the user to review the offers 130, for example by presenting an audible indicator, a visual indicator and/or a vibration indicator. The type of indicator(s) presented to the user can be user selectable. After reviewing the incentives 125 contained in the offer(s) 130, the user can select a credit account to be used to make payment in the financial transaction. The user can select the account by entering an input into the user interface of the electronic device 105, or by entering a user input into the point-of-sale terminal 110. For example, the user can enter the account selection by depressing a key or button on the electronic device 105, touching a touch screen on the electronic device 105 with a stylus or an appendage, or uttering a command detectable by an input audio transducer on the electronic device. Alternatively, the user can enter a user input into the point-of-sale terminal 110 in a similar manner. Nonetheless, user selections can be entered into the electronic device 105 and/or the point-of-sale terminal 110 in any suitable manner and the invention is not limited in this regard.

In an arrangement in which account information 150 for the available credit accounts has already been communicated to the point-of-sale terminal 110, in response to the user selection, an account identifier 160 can be communicated to the point-of-sale terminal 110 to indicate that the selected credit account is to be used to make payment in the financial transaction. In an arrangement in which the point-of-sale terminal 110 has not yet received the account information 150, the account information 150 can be communicated to the point-of-sale terminal 110 after a credit account has been selected. The account information 150 can be limited to the selected credit account, and the point-of-sale terminal 110 can process the payment upon receiving the account information 150. In such an arrangement a separate message to communicate the account identifier 160 may not be necessary.

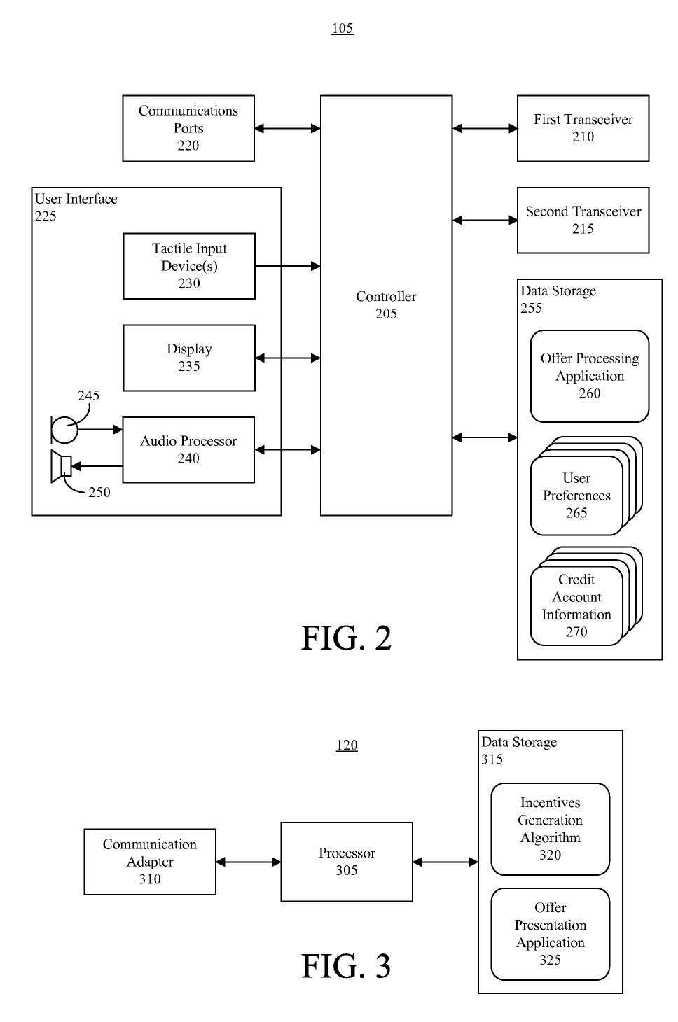

FIG. 2 depicts a block diagram of an example of the electronic device 105 that is useful for understanding the present invention. The electronic device 105 can include a controller 205. The controller 205 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device. In an arrangement in which a plurality of such components are provided, the components can be coupled together to perform various processing functions as described herein.

The electronic device 105 also can include a first transceiver 210. The first transceiver 210 can modulate and demodulate signals to convert signals from one form to another, and can transmit and/or receive such signals over one or more various wireless communication networks. In illustration, the first transceiver 210 can be configured to communicate data via IEEE 802 wireless communications, for example, 802.11 and 802.16 (WiMax), WPA, or WPA2. In another example, the transceiver 210 can communicate data via GSM, TDMA, CDMA, WCDMA, OFDM, or direct wireless communication. Further, the transceiver 210 also can be configured to communicate over a wireless communication link using any of a myriad of communications protocols, for example, TCP/IP.

The first transceiver 210 can receive incentive offers from one or more network nodes. The first transceiver 210 also can receive transaction identifiers from beacons, transponders, and the like. The first transceiver 210 can communicate received information and/or identifiers to the controller 205, or any other suitable electronic device components. The first transceiver 210 also can receive requests, and/or other information from the controller 205 (or other suitable electronic device components) and communicate such information via a communications network. For example, the first transceiver 210 can communicate transaction information to one or more network nodes, as described with reference to FIG. 1 and throughout the specification.

The electronic device 105 also can include a second transceiver 215. The second transceiver 215 also can modulate and demodulate signals to convert signals from one form to another. In one arrangement, the second transceiver 215 can be configured to communicate using near field communications (NFC). In another arrangement, the second transceiver 215 can be configured to communicate using Bluetooth or ZigBee. In yet another arrangement, the second transceiver 215 can communicate via IEEE 802 wireless communications, WPA, WPA2, GSM, TDMA, CDMA, WCDMA or OFDM. Fewer or additional transceivers can be included within the electronic device 105. As such, the particular number of transceivers included within the electronic device 105 and/or the particular communication protocols used are not intended to limit the present invention.

The second transceiver 215 can exchange financial transaction information with point-of-sale terminals, as well as receive transaction identifiers from beacons, transponders, and the like. The second transceiver 215 can communicate to the controller 205 information received from point-of-sale terminals, beacons, transponders, and/or any other received information. Alternatively, such information can be communicated to any other suitable electronic device components. The second transceiver 215 also can communicate information to other devices. For instance, the second transceiver 215 can communicate account information to point-of-sale terminals.

In an alternate arrangement, in lieu of, or in addition to the second transceiver 215, the electronic device 105 can include one or more communications ports 220 used by the electronic device 105 to exchange information with other devices. For example, a communications port 220 can be used by the electronic device to communicate account information to point-of-sale terminals. The communications port 220 can include, for instance, a universal serial bus (USB) port, an IEEE-1394 port, and/or any other suitable communications port(s).

The electronic device 105 also can include a user interface 225 comprising one or more tactile input devices 230 and a display 235. The tactile input devices 230 can comprise one or more buttons, keys, soft keys, sensors, or any other devices suitable for receiving a tactile user input. The display 235 can be a liquid crystal display (LCD), a liquid crystal on silicon (LCOS) display, a cathode ray tube (CRT), a plasma display, or any other suitable display. In one arrangement, the display 235 can comprise a touch screen that can receive tactile and/or stylus inputs and communicate such inputs to the controller 205. The tactile input devices 230 and/or display 235 can receive user inputs to establish user preferences, receive user selections, or perform any other suitable electronic device functions.

The user interface 225 further can include an audio processor 240 connected to an input audio transducer 245 (e.g. microphone) and an output audio transducer 250 (e.g. loudspeaker). The audio processor 240 can be integrated with the controller 205 or provided as a separate component that is communicatively linked to the controller 205. The audio processor 240 can comprise a CPU, a DSP, an ASIC, a PLD, a plurality of discrete components that cooperate to process audio data, and/or any other suitable audio processing device.

The audio processor 240 can receive output audio signals from the controller 205 and communicate such signals to the output audio transducer 250. Similarly, the audio processor 240 can receive input audio signals from the input audio transducer 245 and communicate such signals to the controller 205. In one arrangement, speech recognition can be implemented to process such signals. For example, the controller 205 can execute a speech recognition application to process the audio signals.

Further, additional devices (not shown) can be components of the user interface 225. For instance, the user interface 225 also can include a headset, a speakerphone, or other device(s) communicatively linked to the electronic device 105 via the first transceiver 210, the second transceiver 215, and/or the communications port 220.

The electronic device 105 further can include data storage 255. The data storage 255 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 255 can be integrated into the controller 205, though this need not be the case.

An offer processing application 260, user preferences 265 and credit account information 270 can be contained on the data storage 255. The controller 205 can execute the offer processing application 260 to implement the processes and methods described herein which are allocated to the electronic device 105. For example, during a financial transaction, the offer processing application 260 can be executed to receive offers of incentives available from financial institutions for using particular credit accounts. The controller 205 also can execute the offer processing application 260 to present the offers to a user, to receive a user selection of a credit account to use to make payment in a financial transaction, and to communicate credit account information 270 for the selected credit account to a point-of-sale terminal in order to make a payment for a financial transaction.

At this point it should be noted that the electronic device 105 described in FIG. 2 is but one example of a myriad of electronic devices that can be used in the present invention, and the invention is not limited to this example. As noted, the electronic device 105 can be as simple as a collection of two or more conventional credit cards, or as sophisticated as a mobile station or computer.

FIG. 3 depicts a block diagram of an example of the network node 120 that is useful for understanding the present invention. The network node 120 can include a processor 305, which can comprise one or more CPUs, one or more DSPs, one or more ASICs, one or more PLDs, a plurality of discrete components that can cooperate to process data, and/or any other suitable processing device. In an arrangement in which a plurality of such components are provided, the components can be coupled together to perform various processing functions as described herein.

The network node 120 also can include a communications adapter 310 that is communicatively linked to the processor 305. The communications adapter 310 can be any data send/receive device that is suitable for communicating via a communications network. For example, the communications adapter 310 can be a transceiver that is configured to wirelessly communicate via a base transceiver station, a repeater, an access point, or any other suitable wireless network device. In another arrangement, the communications adapter 310 can be a wired communication port or a network adapter configured to communicate via wired communication, for instance via a switch or a router. The communications adapter can communicate data via GSM, TDMA, CDMA, WCDMA, OFDM, direct wireless communication, TCP/IP and/or any other suitable communication protocols.

The network node also can include a data storage 315. The data storage 315 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 315 can be integrated into the processor 305, though this need not be the case.

An incentives generation algorithm 320 and an offer presentation application 325 can be contained on the data storage 315. The processor 305 can execute the incentives generation algorithm 320 and the offer presentation application 325 to implement the processes and methods described herein which are allocated to the network node 120. For example, at runtime the offer presentation application 325 can receive transaction information from the electronic device and/or the point-of-sale terminal, parse the information, and communicate the parsed information to the incentives generation algorithm 320. As noted, the transaction information can include a credit account identifier, an identifier of a location where the financial transaction is taking place, other credit accounts being considered for use, at least one competing offer, a purchase amount, an identifier of a type of item being purchased, an identifier of a specific item being purchased, an identifier for a type of business associated with the financial transaction, a type of product or service that is the subject of the financial transaction and/or any other information that may be relevant to selection of an incentive to offer to the user.

The incentives generation algorithm 320 can process such information to generate incentives, if any, that may be offered to a user of the electronic device to use a particular credit account to make payment for the transaction. The incentives generation algorithm 320 can pass such incentives to the offer presentation application 325, which can communicate an offer containing one or more of the incentives for presentation to the user of the electronic device. In one arrangement, for example if the credit account is past due or the available credit on the account is less than the purchase amount, the offer presentation application 325 can communicate a message indicating that no incentives are being offered and/or that the credit account is not available to make payment for the transaction.

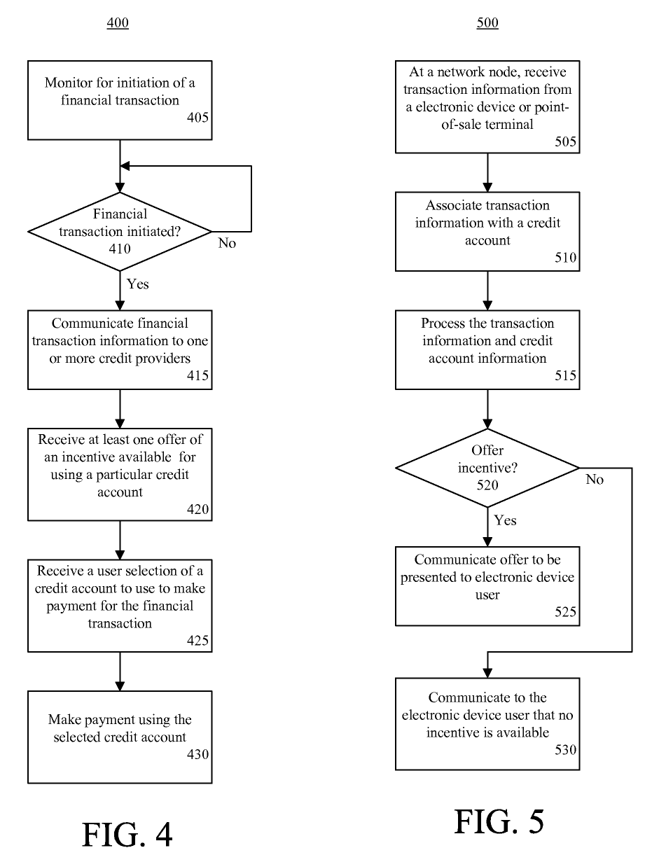

FIG. 4 is a flowchart presenting a method 400 that is useful for understanding the present invention. The method 400 can begin in a state in which an electronic device or a point-of-sale terminal has been configured to receive offers of incentives available from financial institutions and configured to process transaction payments. At step 405, the electronic device can monitor for initiation of a financial transaction with a point-of-sale terminal. Alternatively, the point-of-sale terminal can monitor for initiation of a financial transaction with the electronic device.

Referring to decision box 410, if a financial transaction is initiated, at step 415, the electronic device and/or point-of-sale terminal can communicate transaction information to one or more credit providers. For instance, the transaction information can be communicated to one or more network nodes associated with the credit providers.

At step 420, at least one offer of an incentive for making payment with a particular credit account can be received. The offer can be received by the electronic device or the point-of-sale terminal, and be presented to the user. Continuing to step 425, a user selection of a credit account to use to make payment for the financial transaction can be received on the electronic device. At step 430, the selected credit account can be used to make payment for the financial transaction.

FIG. 5 is a flowchart presenting another method 500 that is useful for understanding the present invention. The method 500 can begin in a state in which a network node (e.g. a server) has been configured to receive transaction information and to provide offers of incentives to a user of an electronic device in order to entice the user to use a particular credit account to make payment for the transaction. Beginning at step 505, the network node can receive transaction information from an electronic device or a point-of-sale terminal. At step 510, the network node can associate the transaction information with a credit account. For example, the network node can parse a credit account identifier from the transaction information. At step 515, the transaction information and information for the credit account can be processed to determine whether to offer an incentive to the user to use the credit account and, if so, what incentive(s) to offer. At decision box 520, if it is decided to offer an incentive, at step 525 the incentive can be communicated to the electronic device or the point-of-sale terminal for presentation to the user. If, however, it is decided not to offer an incentive, the network node can communicate an indicator of such to the electronic device or the point-of-sale terminal for presentation to the user. Moreover, the indicator also can indicate that the credit account is unavailable for making payment in the transaction, for instance if payments to the credit account are past due, the credit available on the credit account is not sufficient to pay for the transaction, or for any other suitable reason.

The present invention can be realized in hardware, software, or a combination of hardware and software. The present invention can be realized in a centralized fashion in one processing system or in a distributed fashion where different elements are spread across several interconnected processing systems. Any kind of processing system or other apparatus adapted for carrying out the methods described herein is suited. A typical combination of hardware and software can be a processing system with an application that, when being loaded and executed, controls the processing system such that it carries out the methods described herein. The present invention also can be embedded in a program storage device readable by a machine, tangibly embodying a program of instructions executable by the machine to perform methods and processes described herein. The present invention also can be embedded in an application product which comprises all the features enabling the implementation of the methods described herein and, which when loaded in a processing system, is able to carry out these methods.

The terms “computer program,” “software,” “application,” variants and/or combinations thereof, in the present context, mean any expression, in any language, code or notation, of a set of instructions intended to cause a system having an information processing capability to perform a particular function either directly or after either or both of the following: a) conversion to another language, code or notation; b) reproduction in a different material form. For example, an application can include, but is not limited to, a subroutine, a function, a procedure, an object method, an object implementation, an executable application, an applet, a servlet, a MIDlet, a source code, an object code, a shared library/dynamic load library and/or other sequence of instructions designed for execution on a processing system.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language).

This invention can be embodied in other forms without departing from the spirit or essential attributes thereof. Accordingly, reference should be made to the following claims, rather than to the foregoing specification, as indicating the scope of the invention.

What is claimed is:

1. A method of conducting a financial transaction, comprising:
in response to initiation of the financial transaction, receiving from each of a plurality of credit providers an offer indicating an incentive available to a user for using an established credit account to make payment for the financial transaction; and
presenting the offers to the user.

2. The method of claim 1, further comprising receiving an identifier associated with each of a plurality of the established credit accounts.

3. The method of claim 2, wherein receiving the identifiers comprises receiving the identifiers from a portable electronic device.

4. The method of claim 2, wherein receiving the identifiers comprises receiving a user input.

5. The method of claim 1, further comprising prompting the user to select one of the established credit accounts to make payment for the financial transaction.

6. The method of claim 1, wherein receiving the offer comprises receiving the offer from the point-of-sale terminal, a portable electronic device, a computer or a network node.

7. The method of claim 1, further comprising:
in response to initiation of the financial transaction, communicating transaction information to the at least one of the credit providers;
wherein receiving the offer indicating the incentive comprises receiving the offer in response to the transaction information.

8. The method of claim 7, wherein communicating the transaction information comprises communicating an identifier for a location where the financial transaction is taking place or a business name at the location.

9. The method of claim 8, wherein communicating the transaction information comprises communicating an identifier for a type of business associated with the financial transaction or a type of product or service that is the subject of the financial transaction.

10. A method of conducting a financial transaction, comprising:
receiving from an electronic device or a point-of-sale terminal transaction information for a financial transaction at the point-of-sale terminal; and
communicating an offer to be presented to a user, the offer indicating an incentive to be provided if a particular credit account is used to make payment for a financial transaction at the point-of-sale terminal.

11. The method of claim 10, further comprising:
processing the transaction information; and
selecting the incentive based upon the transaction information.

12. The method of claim 10, wherein receiving the transaction information comprises receiving an identifier for a location where the financial transaction is taking place, other credit accounts being considered for use, or at least one competing offer.

13. The method of claim 10, wherein receiving the transaction information comprises receiving a purchase amount, an identifier of a type of item being purchased, or an identifier of a specific item being purchased.

14. The method of claim 10, wherein receiving the transaction information comprises receiving an identifier for a type of business associated with the financial transaction or a type of product or service that is the subject of the financial transaction.

15. The method of claim 10, further comprising:
processing financial information associated with the credit account; and
selecting the incentive based upon the financial information.

16. The method of claim 15, wherein processing the financial information associated with the credit account comprises processing a credit rating or a payment history.

17. An electronic device suitably configured to make a payment at a point-of-sale terminal, comprising:
a transceiver that receives from at least one credit provider an offer indicating an incentive available to an electronic device user for using a particular credit account identified on the electronic device to make payment for a financial transaction at a point-of-sale terminal; and
a user interface that, in response to initiation of the financial transaction, presents the incentive to the user.

18. The electronic device of claim 17, wherein the user interface further prompts the electronic device user to select one credit account from among a plurality of credit accounts available to make payment for the financial transaction.

19. The electronic device of claim 17, wherein the transceiver automatically receives the offer in response to initiation of the financial transaction.

20. The electronic device of claim 17, wherein the transceiver receives the offer from the point-of-sale terminal or a network node.
